(19) United States
(12) Patent Application Publication
(10) Pub. No.: US 2005/0217436 A1
(43) Pub. Date: Oct. 6, 2005

(54) Tool and a method for securing a fastener

(76) Inventor: George D. Wolf, Franklin Park, IL (US)

Correspondence Address: PATENTS+TMS, P.C., 2849 W. ARMITAGE AVE., CHICAGO, IL, 60647, US

(21) Appl. No.: 10/816,057

(22) Filed: Apr. 1, 2004

(51) Int. Cl. B25B 13/06

(52) U.S. Cl. 81/124.4

(57) ABSTRACT

A tool for the rotation of sockets, screws, nuts, or other fasteners or the like and a method for securing a fastener are provided. The tool may have a body having an interior area wherein the interior area has walls which are parallel and have sections having different widths between the sections. Further, the tool may have a first portion which may have widths sized to receive fasteners based on, for example, a metric system. A second portion may have widths sized to receive fasteners based on, for example, English units of measurement. The tool may be placed around a fastener wherein the fastener contacts sections which are separated by a width sufficient to fit around the fastener. The tool may then be rotated to secure or remove the fastener.

### BACKGROUND OF THE INVENTION

The present invention generally relates to a tool. More specifically, the present invention relates to a wrench that may enable a user to rotate, for example, sockets, screws, other fasteners or the like. The wrench may be used on, for example, different sized sockets, screws, nuts and other fasteners and may eliminate a need to use different types of tools. Additionally, the present invention relates to a method for securing a fastener.

Traditionally, wrenches are used by service and assembly mechanics and technicians for installing and removing different sized sockets, screws or nuts. A mechanic and/or a technician generally prefers to use a wrench that is convenient or easy to manipulate. The preferred wrench must be sturdy to withstand pressure or torque applied to the wrench.

Known wrenches are generally open-ended wrenches that may have an elongated shank or handle. The open-ended wrenches may also have a wrenching head on an end or on both ends of the shank or handle. The wrench head generally includes two jaws providing smooth planar driving surfaces that engage opposite sides of a socket, a nut or a screw, for example, to be installed.

A disadvantage of such wrenches is that an inadequate gripping force occurs between the driving surfaces and the object. The inadequate gripping force may be due to insufficient engagement of the fastening implement. The open-ended wrench may be pre-designed and pre-sized to engage a specific sized nut, screw and/or fastener. As a result, the wrench may have a tendency to disengage from the nuts, screws, bolts or faster if the wrench is employed to rotate a fastener that is either too large or too small for the pre-sized wrench. The wrench may then strip the nuts, bolts and/or fastener. The wrench may strip the fastener when the wrench is the incorrectly sized to engage a fastener. Further, if, for example, an improperly fitting screw, nut, bolt or fastener may deform and/or spread the wrench jaws of a preformed wrench. Additionally, a wrench may, for example, round and/or strip the fastener the wrench attempts to rotate.

Another disadvantage of the open wrench is that the wrench is not easy to manipulate. Most nuts and screws are made in a pre-designed size and dimension. Similarly, most wrenches are made to fit the fasteners having pre-designed sizes and dimensions. If, for example, a nut or screw has a non-standard size or dimension, the open wrench may not provide enough driving surface to engage the fastener. In the alternative, the open wrench may be too small to engage the fastener.

Further, an individual may, for example, perform a task requiring various sized nuts or fasteners. A known wrench may not have the ability to fasten nuts, screws or the like having different sizes. The individual may have to utilize a corresponding number of wrenches to rotate the different sized fasteners. Therefore, the individual may require several wrenches of different sizes and/or lengths. Transporting or otherwise holding or carrying of the wrenches may be tedious.

A need, therefore, exists for a tool and a method for securing a fastener which may accommodate different sized fasteners. A need also exists for a tool and a method for securing a fastener which may rotate various types of fasteners.

### SUMMARY OF THE PRESENT INVENTION

The present invention relates to a tool which may enable torqueing of different sized sockets, nuts, bolts and other fasteners. Further, the present invention relates to a wrench and a method for securing a fastener nuts, bolts, sockets, other types of fasteners, or the like.

To this end, in an embodiment of the present invention a tool is provided. The tool has a body having an outside perimeter and an inside perimeter wherein the inside perimeter defines an open area. First surfaces are provided around the open area wherein the first surfaces are parallel and separated by a first width in the open area. In addition, the tool has second surfaces around the inside perimeter wherein the second surfaces are parallel and separated by a second width wherein the second width is greater than the first width and one of the first surfaces is co-extensive with one of the second surfaces.

In an embodiment, the tool has grooves in the body of the tool wherein the grooves extend toward the inside perimeter.

In an embodiment, the tool has ridges on the outside perimeter of the tool wherein the ridges are formed by depressions in the body of the tool along the outside perimeter.

In an embodiment, the tool has an indent provided in the inside perimeter separating each of the surfaces.

In an embodiment, the tool has an apex formed along the inside perimeter.

In an embodiment, the tool has third surfaces around the open area wherein the third surfaces are parallel and separated by a third width wherein the third width is greater than the second width and one of the third surfaces is co-extensive with one of the second surfaces.

In another embodiment of the present invention, a fastening device is provided. The fastening device has a body defined between a first end and a second end wherein the body has an outside perimeter. The fastening device also has an interior area within the body having a first wall parallel to a second wall. In addition, indents are provided within the first wall and the second wall wherein the indents divide the first wall and the second wall into sections and wherein a width between the first wall and the second wall increases from the first end to the second end.

In an embodiment, the sections increase in size from the first end to the second end.

In an embodiment, the fastening device has ridges on the outside perimeter of the fastening device wherein the ridges are formed by depressions in the body of the fastening device along the outside perimeter.

In an embodiment, the fastening device has grooves formed in the body of the fastening device wherein the grooves extend toward the interior area.

In an embodiment, the fastening device has an apex at the first end of the fastening device formed by a convergence of the first wall and the second wall.

In an embodiment, the fastening device has first sections in the first wall and the second wall wherein the first sections are separated by a first width. The fastening device further has second sections in the first and the second wall wherein the second sections are separated by a second width wherein the second width is greater than the first width.

In an embodiment, one of the indents in the first wall is aligned with one of the indents in the second wall.

In another embodiment of the present invention, a method for securing a fastener is provided, the method comprising the steps of: providing a tool having a body defined between a first end and a second end wherein the body has an interior area defined by parallel walls wherein the walls have engaging sections wherein the engaging sections are co-extensive and further wherein each of the engaging sections has a different width separating the engaging sections in the interior area; and selecting first engaging sections to contact a fastener wherein the walls of the tool contact the fastener.

In an embodiment, the method comprises the step of moving the tool in a direction to secure the fastener.

In another embodiment of the present invention, a tool is provided. The tool has a body having an outside perimeter and an inside perimeter wherein the inside perimeter defines an open area. The tool also has first surfaces along the inside perimeter wherein the first surfaces are parallel and opposed. Further, the tool has a first section and a second section along each of the first surfaces wherein a first distance exists between opposed first sections and a second distance exists between opposed second sections wherein the first distance is not equal to the second distance. In addition, the tool has second surfaces within the inside perimeter wherein the second surfaces are parallel and opposed and wherein the second surfaces are separated by a distance greater than the first distance and the second distance and further wherein one of the first surfaces is co-extensive with one of the second surfaces.

In an embodiment, the tool has a first section and a second section along each of the second surfaces wherein a first distance exists between opposed first sections and a second distance exists between opposed second sections wherein the first distance is not equal to the second distance.

In an embodiment, the tool has third surfaces co-extensive with the second surfaces wherein the third surface are opposed and parallel.

In an embodiment, the distance between the first sections is based on a first measurement system and the distance between the second sections is based on a second measurement system wherein the first measurement system is not the same as the second measurement system.

In an embodiment, the second surfaces are longer than the first surfaces.

It is, therefore, an advantage of the present invention to provide a tool and a method for securing a fastener that may rotate screws, nuts, bolts and other fasteners.

Another advantage of the present invention is to provide a tool and method for securing a fastener wherein the tool may have an enclosed design.

Still further, an advantage of the present invention is to provide a tool and a method for securing a fastener wherein the tool may have a plurality of tracks contained within an enclosed designed for engaging fasteners of different sizes.

Yet another advantage of the present invention is to provide a tool and a method for securing a fastener wherein the tool may be used in restrictive or tight areas.

Another advantage of the present invention is to provide a tool and a method for securing a fastener wherein the tool may be integrally formed to provide higher strength and rigidity than known tools.

Yet another advantage of the present invention is to provide a tool and a method for securing a fastener wherein an interior of the tool may be of varying shapes and widths.

Still another advantage of the present invention is to provide a tool and a method for securing a fastener wherein the tool may have tracks having different lengths to engage different sized fasteners.

Another advantage of the present invention is to provide a tool and a method for securing a fastener wherein the tool may contain grooves for easy engagement and handling of the tool.

And, an advantage of the present invention is to provide a tool and a method for securing a fastener wherein the tools may have knurls along a perimeter of the tool.

Another advantage of the present invention is to provide a tool and a method for securing a fastener wherein the tool may have knurls to aid in gripping the tool.

Yet another advantage of the present invention is to provide a tool and a method for securing a fastener wherein the tool may withstand increased levels of torque applied to the tool.

Another advantage of the present invention is to provide a tool and a method for securing a fastener wherein the tool may transfer increased levels of torque to a nut, bolt, screw or other fastener.

Another advantage of the present invention is to provide a tool and a method for securing a fastener wherein the tool is a single-piece construction which may be designed to fit a hand of a user.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a wrench in an embodiment of the present invention.

FIG. 2 illustrates a top view of the wrench of FIG. 1.

FIG. 3 illustrates a perspective view of a wrench in an embodiment of the present invention.

FIG. 4 illustrates a top view of the wrench of FIG. 3.

### DETAILED DESCRIPTION OF THE PRESENTLY PREFERRED EMBODIMENTS

The present invention generally relates to a tool for rotating sockets, screws, fasteners or the like. Further, the present invention relates to a wrench which may provide a user with leverage and/or torque for securing or removing fasteners. The wrench may enable fastening of different sized sockets, screws or nuts, for example.

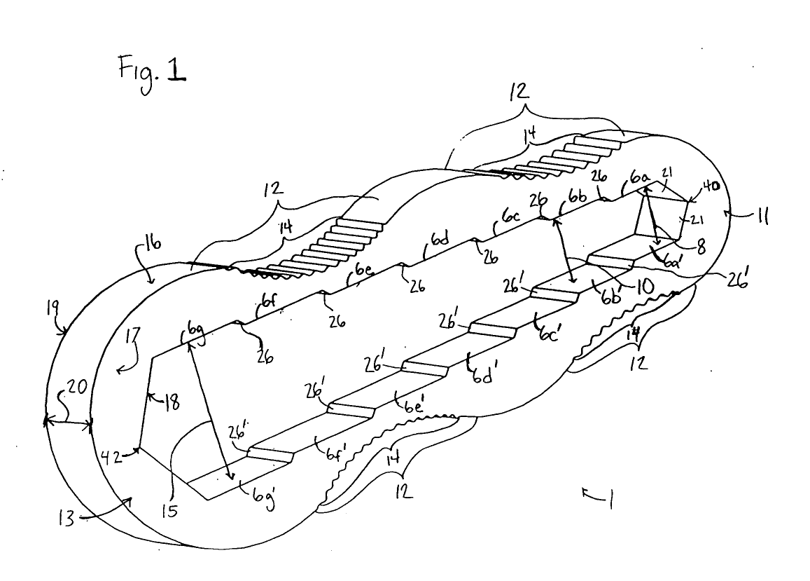

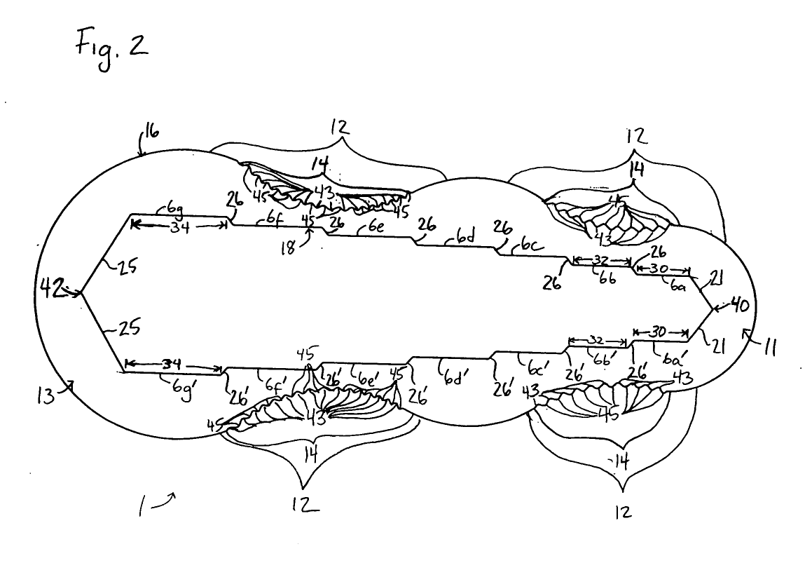

Referring now to the drawings, wherein like numerals refer to like parts, FIG. 1 illustrates a wrench 1 having an outside perimeter 16 and an inside perimeter 18. The wrench 1 may have surfaces, or tracks 6a through 6g within the inside perimeter 18. As shown in the embodiment in FIGS. 1 and 2, the wrench 1 may have seven sets of tracks 6a through 6g. However, any number of tracks may be implemented in the wrench 1. The tracks 6a through 6g may be directly opposed and/or parallel. In an example, the track 6a may be parallel to the track 6a′.

Further, directly opposed tracks 6a through 6g may have different widths separating the tracks 6a through 6g. For example, a width 8 may separate the track 6a and the track 6a′. Likewise, the track 6b may be separated from the track 6b′ by a width 10. The width 10 may be greater than the width 8. In addition, the track 6g on the side 21 may be separated from track 6g on the side 25 by a width 15. The width 15 may be greater than the width 10. Moreover, a width separating each set of tracks 6a through 6g may increase from a first end 11 of the wrench 1 to a second end 13 of the wrench 1, i.e., may increase from the width 8 to the width 15.

Directly opposed tracks may have equal lengths. For example, the track 6a may have a length 30. The track 6a′ may also have the length 30. In addition, adjacent tracks 6a through 6g may have different lengths, as illustrated in FIG. 2. For example, the track 6a may have a length 30. The track 6b may have a length 32. The length 32 may be greater than the length 30. Further, the track 6g may have a length 34. In a preferred embodiment, the length of each of the adjacent tracks 6a through 6g may increase from the first end 11 of the wrench 1 to the second end 13 of the wrench 1, i.e., increase from the length 30 to the length 34.

The different widths between the opposing tracks 6a through 6g may enable the wrench 1 to engage fasteners of different sizes and/or types. For example, a first fastener (not shown) may be engaged by contacting the fastener with the tracks 6a, 6a′. Moreover, the inside perimeter 18 may have walls 21 which form an apex 40. The walls 21 may be sized and angled to contact a perimeter of the fastener which may fit within the tracks 6a, 6a′.

A second fastener (not shown), having a size greater than the first fastener may be engaged by tracks 6b, 6b′. If the second fastener is too large to fit within the tracks 6b,6b′, a user may engage the second fastener between one of the opposed tracks 6c through 6g which have a greater width. Moreover, the inside perimeter 18 may also have walls 25 which form an apex 42 at the end 13 of the wrench 1. The walls 25 may be sized and angled to contact a perimeter of the fastener which may fit within the tracks 6g, 6g′. In an embodiment, the first fastener and the second fastener may also be different types of fasteners.

The wrench 1 illustrated in FIGS. 1 and 2 may be shaped to have grooves 12 which may be rounded and may extend toward the inside perimeter 18 of the wrench 1. Ridges, or knurls 14, may be formed along the grooves 12 on the outside perimeter 16 of the wrench 1. The knurls 14 may be defined by depressions 43 and peaks 45 along the outside perimeter of the 16 of the wrench 1. The depressions 43 and the peaks 45 may be separated by, for example, one millimeter. The knurls 14 may provide a gripping surface for the user when holding the wrench 1. Moreover, the knurls 14 may enable the user to apply pressure and/or torque to the wrench 1 and may prevent the wrench 1 from slipping from, for example, a hand of the user.

The wrench 1 may have a thickness 20 defined by a distance between a first surface 17 and a second surface 19, illustrated in FIG. 1. The thickness 20, as well as the shape of the wrench 1, may provide the wrench 1 with a tensile strength sufficient to withstand torque applied to the wrench 1. The tensile strength of the wrench 1 may prevent deformation of the wrench 1, in contrast to known wrenches which become misshapen when torque is applied. In a preferred embodiment, the wrench 1 may withstand, for example, twenty foot pounds of torque on a half inch bolt.

FIG. 2 generally illustrates a top view of the wrench 1. The tracks 6a through 6g may be separated from one another by grades 26, 26′. The grades 26, 26′ may be, for example, a step, or indentation, that may separate each of the tracks 6a through 6g, and 6a′ through 6g′.

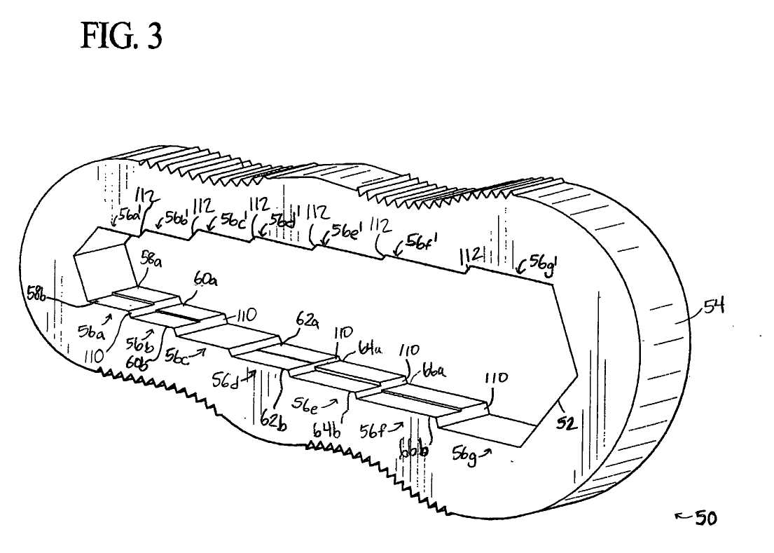

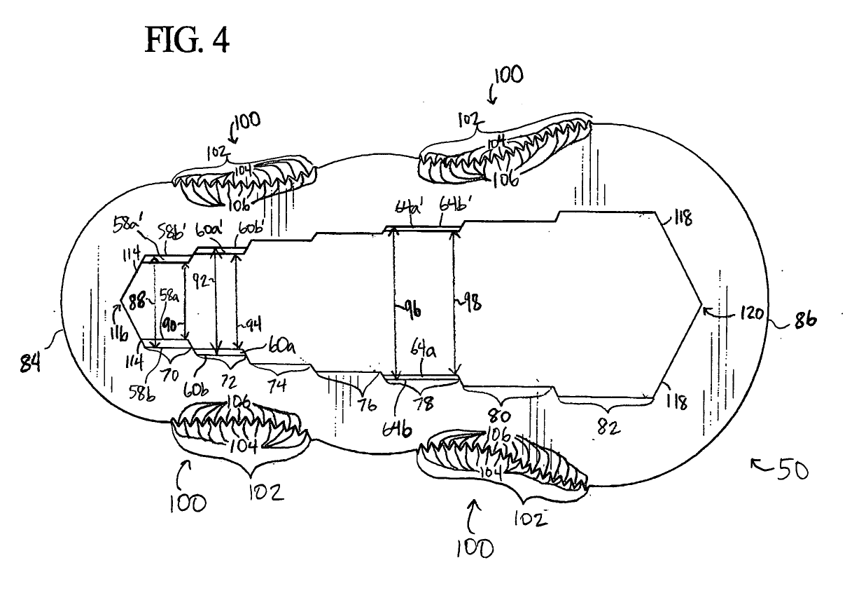

FIGS. 3 and 4 illustrate a wrench 50 in another embodiment of the present invention. The wrench 50 may have an inside perimeter 52 and an outside perimeter 54. Surfaces, or tracks 56a through 56g, may be formed within the wrench 50 along the inside perimeter 52. FIGS. 3 and 4 illustrate seven tracks 56a through 56g formed within the wrench 50; however, any number of tracks suitable for engaging fasteners of different sizes may be implemented. Each set of tracks 56a through 56g may be directly opposed and/or parallel. In an example, the track 56a may be parallel to the track 56a′. The tracks 56a through 56g may be separated from one another by grades 110, 112. The grades 110, 112 may be, for example, a step, or indentation, that may separate each of the tracks 56a through 56g.

The tracks 56a through 56g may have lengths 70, 72, 74, 76, 78, 80 and 82, respectively. The length of each set of tracks may increase from an end 84 of the wrench 50 to an end 86. In an example, the length 82 of tracks 56g, 56g′ may be greater than the length 78 of tracks 56e, 56e′. Moreover, the length 78 of tracks 56e, 56e′ may be greater than the length 70 of tracks 56a, 56a′.

The tracks 56a may be divided into sections 58a and 58b; the tracks 56b may be divided into sections 60a and 60b; the tracks 56d may be divided into sections 62a and 62b; the tracks 56e may be divided into sections 64a and 64b; and the tracks 56f may be divided into sections 66a and 66b. Each set of the sections may be opposed and/or parallel. A width 88 between sections 58b, 58b′ may be greater than a width 90 between sections 58a, 58a′. A width 92 between sections 60b, 60b′ may be greater than a width 94 between sections 60a, 60a′. A width 96 between sections 64b, 64b′ may be greater than a width 98 between sections 64a, 64a′. In general, a width between the tracks 56a through 56g may increase from the end 84 to the end 86.

Differing widths between adjacent sections in each of the tracks 56a through 56g may enable the wrench 50 to accommodate fasteners from various measurement systems. In an example, widths between sections 58a, 60a, 62a, 64a and 66a may be sized to accommodate fasteners which are sized based on, for example, a metric system. Widths between sections 58b, 60b, 62b, 64b and 66b may be sized to accommodate fasteners which are sized based on, for example, an English measurement system. In an embodiment, fasteners which may be sized based on differing units of measurement may have equal widths (i.e., a first fastener having a width of 2.5 cm and a second fastener having a width of 1 inch). Accordingly, the wrench 50 may contain tracks 56c, 56c′ which may not be divided into sections having different widths.

As illustrated in FIG. 4, the inside perimeter 54 may also have walls 114 which form an apex 116 at the end 84 of the wrench 50. The inside perimeter 54 may also have walls 118 which form an apex 120 at the end 86 of the wrench 50. The walls 114, 118 may be sized and angled to contact a perimeter of the fastener which may fit within the tracks 56a or 56g.

The wrench 50 may be shaped to have grooves 100 which may be rounded and may extend toward the inside perimeter 52 of the wrench 50. Ridges, or knurls 102, may be formed along the grooves 100 on the outside perimeter 54 of the wrench 50. The knurls 102 may be defined by depressions 104 and peaks 106 along the outside perimeter 54 of the wrench 50. The depressions 104 and the peaks 106 may be separated by, for example, one millimeter. The knurls 102 may provide a gripping surface for the user when holding the wrench 50. Moreover, the knurls 102 may enable the user to apply pressure and/or torque to the wrench 50 and may prevent the wrench 50 from slipping from, for example, a hand of the user.

The wrenches 1, 50 of the present invention may be constructed as a single forged part, i.e., integrally formed. The advantage of forging the wrenches 1, 50 may be an improved tensile strength of the material used for constructing the wrenches 1, 50. Accordingly, the wrenches 1, 50 may withstand increased levels of torque and pressure applied to the wrenches 1, 50, as opposed to known wrenches.

The wrenches 1, 50 may, for example, be used by a homeowner, technician, mechanic or any other individual having a need for a tool that may fit one or more fasteners. To this end, the user may grip either of the wrenches 1 or 50, for example, by the grooves 12, 100, on the outside perimeter 16, 54. The user may place either of the wrenches 1 or 50, around a fastener (not shown) which is to be secured or removed. The fastener may then be positioned within the inside perimeter 18, 52. The user may then determine which set of tracks 6a through 6g, or 56a through 56g is sized to fit around a perimeter of the fastener and contact the fastener. If the wrench 1 is implemented, the user may place the appropriate tracks 6a through 6g adjacent to the fastener.

If the wrench 50 is implemented, the user may determine which sections 58a, 58b, 60a, 60b, 62a, 62b, 64a, 64b, 66a or 66b may provide the most secure fit around a fastener depending on the measurement system from which the size of the fastener is based. In an example, the fastener which is to be secured may be sized based on a metric system. The user may rotate the wrench 50 to engage the fastener between one of the set of the sections 58a, 58a′, 60a, 60a′, 62a, 62a′, or 64a, 64a′, which may be separated by widths based on the metric system. In another example, the fastener may be sized based on English units of measurement. The user may rotate the wrench 50 to engage the fastener between one of the set of sections 58b, 58b′, 60b, 60b′, 62b, 62b′, or 64b, 64b′, which may, for example, be separated by widths based on English units of measurement.

Known methods for securing or removing fasteners of different sizes require a separate tool for each of the differently sized fasteners. However, the wrenches 1, 50 may have different lengths for the tracks 6a through 6g, or 56a through 56g, and different widths between the tracks 6a through 6g, or 56a through 56g. As a result, the wrenches 1, 50 may fit around, and secure or remove, fasteners of different sizes. Accordingly, the wrenches 1, 50 may eliminate a need for additional tools for securing or removing fasteners having different sizes.

In addition, the shape of the wrenches 1, 50 may be compact in comparison to known wrenches. As a result, the wrenches 1, 50 may be used in tight or confining areas in which known wrenches do not fit. Moreover, the compact shape of the wrenches 1, 50 may enable the user to transport either of the wrenches 1, 50 with convenience in comparison to known wrenches.

It should be understood that various changes and modifications to the presently preferred embodiments described herein will be apparent to those skilled in the art. Such changes and modifications may be made without departing from the spirit and scope of the present invention and without diminishing its attendant advantages.

1. A tool comprising:
a body having an outside perimeter and an inside perimeter wherein the inside perimeter defines an open area;
first surfaces around the open area wherein the first surfaces are parallel and separated by a first width in the open area; and
second surfaces around the inside perimeter wherein the second surfaces are parallel and separated by a second width wherein the second width is greater than the first width and one of the first surfaces is co-extensive with one of the second surfaces.

2. The tool of claim 1 further comprising:
grooves in the body of the tool wherein the grooves extend toward the inside-perimeter.

3. The tool of claim 1 further comprising:
ridges on the outside perimeter of the tool wherein the ridges are formed by depressions in the body of the tool along the outside perimeter.

4. The tool of claim 1 further comprising:
an indent in the inside perimeter separating each of the surfaces.

5. The tool of claim 1 further comprising:
an apex formed along the inside perimeter.

6. The tool of claim 1 further comprising:
third surfaces around the open area wherein the third surfaces are parallel and separated by a third width wherein the third width is greater than the second width and one of the third surfaces is co-extensive with one of the second surfaces.

7. A fastening device comprising:
a body defined between a first end and a second end wherein the body has an outside perimeter;
an interior area within the body having a first wall parallel to a second wall; and
indents within the first wall and the second wall wherein the indents divide the first wall and the second wall into sections and wherein a width between the first wall and the second wall increases from the first end to the second end.

8. The fastening device of claim 7 wherein the sections increase in size from the first end to the second end.

9. The fastening device of claim 7 further comprising:
ridges on the outside perimeter of the fastening device wherein the ridges are formed by depressions in the body of the fastening device along the outside perimeter.

10. The fastening device of claim 7 further comprising:
grooves formed in the body of the fastening device wherein the grooves extend toward the interior area.

11. The fastening device of claim 7 further comprising:
an apex at the first end of the fastening device formed by a convergence of the first wall and the second wall.

12. The fastening device of claim 7 further comprising:
first sections in the first wall and the second wall wherein the first sections are separated by a first width; and
second sections in the first and the second wall wherein the second sections are separated by a second width wherein the second width is greater than the first width.

13. The fastening device of claim 7 wherein one of the indents in the first wall is aligned with one of the indents in the second wall.

14. A method for securing a fastener, the method comprising the steps of:
providing a tool having a body defined between a first end and a second end wherein the body has an interior area defined by parallel walls wherein the walls have engaging sections wherein the engaging sections are co-extensive and further wherein each of the engaging sections has a different width separating the engaging sections in the interior area; and
selecting first engaging sections to contact the fastener wherein the walls of the tool contact the fastener.

15. The method of claim 14 further comprising the step of:
moving the tool in a direction to secure the fastener.

16. A tool comprising:
a body having an outside perimeter and an inside perimeter wherein the inside perimeter defines an open area;
first surfaces along the inside perimeter wherein the first surfaces are parallel and opposed;
a first section and a second section along each of the first surfaces wherein a first distance exists between opposed first sections and a second distance exists between opposed second sections wherein the first distance is not equal to the second distance; and
second surfaces within the inside perimeter wherein the second surfaces are parallel and opposed and wherein the second surfaces are separated by a distance greater than the first distance and the second distance and further wherein one of the first surfaces is co-extensive with one of the second surfaces.

17. The tool of claim 16 further comprising:
a first section and a second section along each of the second surfaces wherein a first distance exists between opposed first sections and a second distance exists between opposed second sections wherein the first distance is not equal to the second distance.

18. The tool of claim 16 further comprising:
third surfaces co-extensive with the second surfaces wherein the third surface are opposed and parallel.

19. The tool of claim 16 wherein the distance between the first sections is based on a first measurement system and the distance between the second sections is based on a second measurement system wherein the first measurement system is not the same as the second measurement system.

20. The tool of claim 16 wherein the second surfaces are longer than the first surfaces.
